(19) United States
(12) Patent Application Publication
(10) Pub. No.: US 2003/0051004 A1
(43) Pub. Date: Mar. 13, 2003

(54) Method and a system for distributing and reproducing digital information, preferably audio and video information

(76) Inventors: Emilio Bolocco C., Santiago (CL); Felipe Albornoz A., Santiago (CL); Alexander Mella M., Santiago (CL)

Correspondence Address: SHLESINGER, ARKWRIGHT & GARVEY LLP, 3000 South Eads Street, Arlington, VA, 22202, US

(21) Appl. No.: 09/950,624

(22) Filed: Sep. 13, 2001

(51) Int. Cl. G06F 15/16

(52) U.S. Cl. 709/219

(57) ABSTRACT

The present invention discloses a method for distributing and reproducing digital information, preferably audio and video information. The invention allows the interaction of four types of units or entities, which are engaged in the storage, selection, distribution and execution of files containing digital information, preferably, although not limited to, audio and video information. Some of these units or entities exist in, at least, two modalities within the system: global or server mode and terminal or client mode.

### BACKGROUND OF THE INVENTION

1. Field of the Invention

The present invention is related to a method for distributing and reproducing digital information, preferably audio and video information. The invention also relates to a system for carrying out such a method.

In a more particular way, the invention allows the interaction of four types of units or entities, which are engaged in the storage, selection, distribution, and execution of files containing digital information, preferably, although not limited to, audio and video information. Some of these units or entities exist in, at least, two modalities within the system: global or server mode and terminal or client mode. Such is the case of the units for “centralized file storage and management” and the units for “local storage and selection”, respectively.

2. Description of the Related Art

One of the most fundamental differences between the system of the present invention and the behavior of a traditional computer network lies in the fact that in a traditional network with at least one server, and with at least one terminal (either dedicated or intelligent), usually there is a relatively indiscriminate access to a group of files stored in the server area, which does not occur in the system of the present invention. In the case of some traditional networks, like Internet, this difference is even more pronounced, since all the communications between servers and users, with a previous authorization from the user or client (unilateral requirements or commands from a terminal to the server) and the results of these actions from the user consist in the transfer of digital files from the remote server locus, with the subsequent delay of the process until the file or files have been completely downloaded into the terminal commanded by said user. Contrariwise, in the present invention, the actions of file transfer from a server to a terminal are exclusively controlled by a server (unilateral requirements or commands from a server to one or more terminals), being the terminal absolutely submitted to receive the files from the server.

Stated in a different manner, in the case of the present invention, a terminal spontaneously and indiscriminately receives the digital files sent by a server, with the terminal being unable to request files from the server, either by its own or by the user's action, a fact whose representation is intended in FIG. 1b by means of the dotted line (20), which simulates a “semi-permeable” barrier for the system control actions. That is, in relation to the servers, the terminal may deliver information, but will not be able to request it; while any of the servers will be able both to deliver and request information toward any of the terminals.

As a consequence of the above-stated, every time that the user interacts with a terminal, the reach of his/her voluntary actions will be local, not remote, that is to say, such a terminal will only be able to search for, select and execute digital files which are locally stored in that terminal (a fact that allows a more speedy response from the system to the user than in the case of remote access to the files).

On the other hand, in the case of a traditional network, such as Internet, the terminal receives from the server basically those specifically requested digital files (either through an explicit or implicit request, that is, files will be received which have been requested or authorized by the user or the operative system of the terminal).

One of the objectives of the present invention consists in remotely loading a repertory of digital files, from one or more server centers, to one or more client terminals, preferably at moments in which a user is not utilizing the terminal.

Another objective of the present invention consists in establishing communication between one or more servers and one or more terminals, unilaterally controlled by one or more server centers; that is to say, one or more servers of the system may deliver or query for information each client, but the user who is located at a terminal will not be able to communicate with the servers through the system of the invention.

A further objective of the present invention consists in offering at a terminal a repertory of digital files, locally stored, with the user being able to select one or more files from said repertory for playback.

Another objective of the present invention consists in providing each terminal with validation means to authorize or deny the local execution of the digital files selected by a determined user. These validation means may handle one or more types of access, such as a magnetic card, password entry, cash or token deposit, among other types.

Another alternative objective of the present invention consists in allowing the suspension of the validation requisite for a determined user by applying a predetermined criterion in the terminal or in one of the servers, such as the occurrence of a random-type event, etc. and, under these conditions, allow the playback of one or more digital files

In the present description, some terms will be used with the specific meaning given below, unless otherwise specified, and independently from the meaning that might be given to those terms in the usual technical language:

SERVER: one or more subsystems engaged in the control of the communications of the system. A server able to look up information contained in other servers of the system or in the various terminals of said system. A server includes process units, information storage units (temporary memory and/or read-only memory), input and output units for data; interfaces for communications between other servers and terminals of the system.

CLIENT: each of the subsystems made up by a terminal and a user.

TERMINAL: a subsystem that presents two types of behavior, depending on whether it receives a signal from a server of the system or if it receives a signal from the client. If it receives a signal from a server, even if there is no activation required by the user of this terminal, a bilateral communication is established between the server and the terminal If the terminal receives a signal from a user, even if there is no participation of a server, a bilateral communication is established between the terminal and the user; being the user unable to communicate, through his/her terminal, with the servers of the system; with the user being able —at the most— to answer queries made by the terminal either per request of such terminal or from a server of the system. A terminal includes process units, information storage units (temporary memory and/or read-only memory), input and output units for data; and interfaces for communications among other servers of the system.

USER: a person who can interact with a single terminal, previous validation, with the sole purpose of being able to search for, select, and command the execution of one or more digital files locally stored in his/her terminal or with the purpose of responding to specific queries made by the terminal

BILATERAL (and its opposite: UNILATERAL): in the present description, these concepts are used to categorize the mode of the requirements or requests for information or data among the servers, or among the terminals, or between both of them, as indicated. Thus, a unilateral requirement from a server to a terminal means that the former may make a request for information or may make a record in said terminal, but the reverse process (terminal toward server) is neither permitted nor defined.

BIDIRECTIONAL (and its opposite: UNIDIRECTIONAL): in the present description, these concepts are used to categorize the direction of the flow of information among servers, or among terminals, or between both of them, as indicated.

### BRIEF DESCRIPTION OF DRAWINGS

For a better understanding of the invention, it will be described in detail, with support from the drawings, where:

FIG. 1a corresponds to a simplified scheme of communications between a terminal and a server connected in a traditional network, such as Internet;

FIG. 1b corresponds to a simplified scheme of communications between a terminal and a server according to the present invention;

FIG. 2 corresponds to a scheme that illustrates the possible manners of interconnecting the various servers to the diverse terminals. In this figure, the representation of the relationship server-terminal has been simplified, by omitting the drawing of some components illustrated in FIG. 1b.

### DETAILED DESCRIPTION OF INVENTION

In the description and claims which are detailed below, whenever a reference is made to a “server” or a “terminal”, it must be understood that one or more servers or terminals are involved within the system of the invention, respectively, unless otherwise specified.

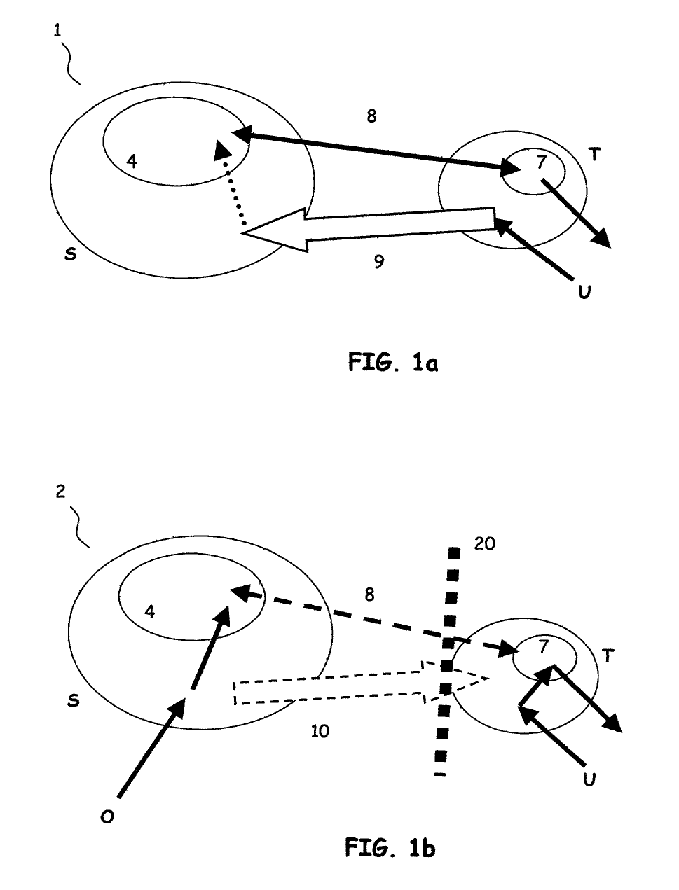

FIGS. 1a and 1b, show, in a schematic and simplified manner, communications systems between a server (S) and a terminal (T) for the bi-directional transference (8) of information, in accordance with a traditional system, (see FIG. 1a), and according to the invention, (see FIG. 1b), respectively; where the bilateral transfer (8) of information is controlled in a unilateral manner from the terminal (T) to the server (S), as shown in FIG. 1a (arrow 9); or said information is controlled in a unilateral manner from the server (S) to the terminal (T), as shown in FIG. 1b (arrow 10). In both cases, the server (S) is providing with the means for massive storage of digital information (4), which may consist, preferably, of digital files and/or databases. On the other hand, each terminal (T) has corresponding local means of massive storage of digital information (7). In both cases, there are channels for remote bi-directional transference of digital information (8), which is substantially commanded in a unilateral manner (9) from the terminal (T) to the server (S) in the case of the state-of-the-art, and, on the contrary, such an information is unilaterally commanded (10) from the server (S) to the terminal (T), in the case of the present invention.

In the system of the invention, the means for massive storage of digital information (4) of the server (S) act as an information source and the means for massive storage of digital information (7) of the terminal (T) substantially act as information receivers, in relation to the server (S), and they substantially act as a source of information in relation to the remaining elements of the terminal itself (T), under the circumstances listed below. When the means for massive storage of digital information (7) are stated to “substantially” act as receivers in one case and “substantially” act as sources in the other, the intention is to refer to their main or basic function (storage of audio or video digital files, preferably); nevertheless, such means (7) may accessorily or secondarily act, additionally, in the reverse mode (as autonomous sources or receivers, respectively) in relation to the storage of certain information for control, such as the storage of statistical data that reflect the actions and/or preferences of the user (U) of the terminal (T).

Another characteristic of the invention itself, different from the state-of-the-art systems, lies in the fact that the channel for digital information transfer (8) and control (10) of the server (S) remains inactive when the terminal (T) is being used by the user (U), which has been intended to be represented through the dotted lines drawn in arrows (8) and (10) of FIG. 1b.

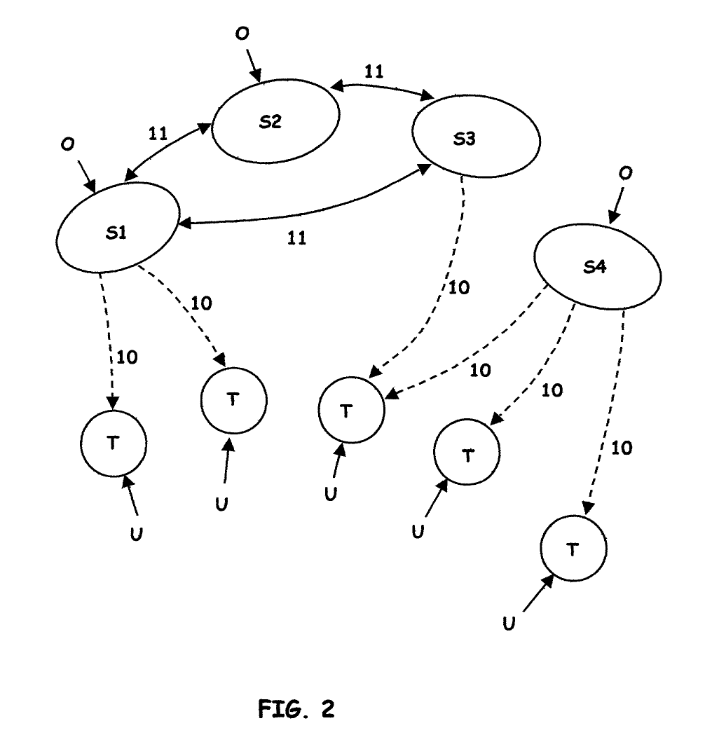

In accordance with the above (see also FIG. 2), the system of the present invention consists of one or more server units (S), connected among themselves by bilateral control channels (11), with at least one server (S) connected to one or more terminals (T), but in such a way that all terminals (T) are connected, at least, to one server (S), solely through unilateral control channels (10) which act from the server or servers (S) to the respective terminal (T). In general, but not limited to, the terminals (T) are not directly connected among themselves.

As shown in FIG. 2, each server must not necessarily be connected to some terminal (T) and, neither is it necessary that all servers (S) are commanded by a human operator (O) but, as previously stated, it is a requisite that all terminals (T) are linked with at least one server (S). For instance, in FIG. 2, server (S1) and server (S2) are commanded by a human operator (O), which might be useful to process and exchange information that requires a preset treatment whose nature does not require human intervention, but where it may be desirable to assign it a substantially exclusive dedication, as it occurs with the data compression treatment, for example. However, the server (S3) has been represented as connected to a terminal (T), which is not a requisite, but it represents a delivery or a request for information from a terminal, according to orders given by another server, such as (S2), which is governed by a human operator (O).

On the other hand, in FIG. 2 the server (S2) has been represented as unconnected to any terminal (T), performing, for instance, functions of coordination among the other servers (S).

Also the system of the invention comprises the possibility that there is a certain server (S4) that is not connected to any other server (S), but in this case it must be commanded by a human operator (O) and it must be connected to, at least, one terminal (T).

In brief, and according to the scheme of FIG. 2, the type of relationships of the elements intervening in the system must comply with the following statements:

Two or more servers (S) of the system may be interconnected—physically or virtually—among themselves, forming network units, or not be connected among themselves, defining themselves as independent servers (S).

Each terminal (T) must be connected to at least one server (S) of the system, through a unilateral control channel (10), which acts from the server or servers (S) toward said terminal (T);

Each network unit or each independent server (S) must be connected to at least one terminal (T), through a unilateral control channel (10), which acts from one or more of the servers (S) of one or more network units and/or from the independent server or servers (S) towards at least such one terminal (T);

Each network unit or each independent server (S) must be commanded by at least one human operator (O);

One or more servers (S) may be not connected to any terminal (T), only if this type of server or servers (S) belongs to a network unit.

According to the characteristics formerly defined, the communications among the servers (S) and among these servers (S) and any of the terminals (T) of the system may be controlled by one or more of any of the servers (S), but such a communication cannot be commanded by any terminal (T). In this way, from a first predetermined server (S) the loading of digital files can be commanded (for example to make a repertory) toward one or more preselected terminals but, if one or more digital files to be loaded is not found in the massive storage means (4) of said first predetermined server (S), this one can query other servers (S) of the system so that, if the missing file or files are found in one of them, the new one relieves the predetermined server of the task of downloading toward the preselected terminal or terminals (T).

What I claim is:

1. A system to distribute and reproduce digital information, preferably audio and video information, the system being of the type that includes at least one server unit and at least one terminal unit, with two or more servers able to be connected among themselves, defining a network unit, said system being with its server and terminal units connected among themselves by means of control channels and data transfer channels, so that at least the following is accomplished:
a) each terminal is connected to at least one system server, through a unilateral control channel, which acts from the server or servers toward said terminal, with a terminal unable to exert any control over a server or group of servers interconnected among themselves;
b) each network unit, or each independent server is connected to at least one terminal, through a unilateral control channel, which acts from one or more servers of one or more network units and/or acts from one or more independent servers, to command such, at least, one terminal;
c) each network unit or each independent server is governed by at least one human operator; and
d) one or more servers may be unconnected to any terminal, only if this type of server belongs to a network unit,
one server unit having, at least, massive digital information storage means, and each terminal unit having massive digital information storage means; and each terminal unit having information input means to allow a user to make one or more selections offered from an options menu; each terminal unit having digital information output units, such as multimedia playback units.

2. A method to distribute and reproduce digital information, preferably audio and video information, used by the system defined in claim 1, where such a procedure comprises at least the following steps:
a) loading from a remote locus, from one or more server units, one or more terminals, with a repertory of digital files, preferably at moments in which the destination terminal of such a load is not being used by a user;
b) storing in the respective terminal the digital file or files that were sent from one or more servers;
c) deleting, from one or more server units, the digital files stored in a terminal, which no longer will be available for such a terminal;
d) updating, from one or more server units, a menu of options in a terminal, to reflect the digital files available in said terminal;
e) activating and/or deactivating one or more terminals, from one or more servers so that, when such terminals become activated they may:
offer a menu of options, per request of a respective user;
process a choice of the menu of options selected by said user; and
execute the digital file associated to such option selected.

3. A method to distribute and reproduce digital information, such as the one in claim 2, where additionally one or more terminals may be provided, from one or more server units, with validation means from the user of the corresponding terminal, to authorize or deny the local execution of the digital files selected by such a user.

4. A method to distribute and reproduce digital information, such as the one in claim 3, where said validation means, located within a terminal, may process one or more types of access modes from the user, such as a magnetic card, password typing, cash or token deposit, or similar ones.
